(19) United States
(12) Patent Application Publication
(10) Pub. No.: US 2026/0176211 A1
(43) Pub. Date: Jun. 25, 2026

(54) Adsorbent Materials for Mineral Soils

(71) Applicant: LANXESS Deutschland GmbH, Cologne (DE)

(72) Inventors: Juergen Kischkewitz, Ratingen (DE); Andreas Schlegel, Krefeld (DE); Jan Siemens, Wettenberg (DE); Anne Wagner, Berlin (DE); Martin Kaupenjohann, Berlin (DE)

(73) Assignee: LANXESS Deutschland GmbH, Cologne (DE)

(21) Appl. No.: 18/711,648

(22) PCT Filed: Nov. 25, 2022
(86) PCT No.: PCT/EP2022/083311

§ 371 Date: May 20, 2024

(30) Foreign Application Priority Data
Nov. 21, 2021 (EP) 21210540.7

(51) Int. Cl. C05D 9/00; B01J 20/10; B01J 20/28; B01J 20/30; C02F 1/28

(52) U.S. Cl. CPC C05D 9/00; B01J 20/10; B01J 20/28004; B01J 20/2803; B01J 20/3078; C02F 1/288

(57) ABSTRACT

The present invention relates to adsorbent material that contains at least subsoil and at least one adsorbent, to mineral soils containing such adsorbent materials, to a process for producing the adsorbent materials, to a process for producing mineral soils that contain such adsorbent materials, to the use of adsorbents for producing adsorbent materials, and to the use of adsorbent materials for producing mineral soils.

The present invention relates to adsorber material containing at least subsoil and at least one adsorbent, to mineral soils containing such adsorber materials, to methods for producing such adsorber materials, to methods for producing mineral soils containing such adsorber materials, to the use of adsorbents for production of adsorber materials, and to the use of adsorber materials for production of mineral soils.

Soils are formed on the earth's surface in the region of overlap between atmosphere, lithosphere, hydrosphere and biosphere through the interaction of the soil-forming factors rock, climate, vegetation, flora/fauna, relief, water and humans. Soil is understood by a person skilled in the art to mean a three-phase system composed of solid mineral and organic matter and of voids, part of which is water-filled and part of which is air-filled.

Soils are divided into horizons. Soil horizons are regions within the soil that have uniformly similar features and properties and differ from overlying or underlying regions in one or more features. The upper three mineral soil horizons are divided as follows: topsoil (A horizon), subsoil (B horizon) and parent rock (C horizon). Topsoil is understood by a person skilled in the art as the soil horizon which is enriched with organic matter, which is generally distinguishable from the underlying subsoil on the basis of its dark color and which exhibits strong root penetration. The different colors of the topsoil and subsoil of a soil sample can be identified purely visually and can also be quantitatively determined using special color charts, for example the Munsell Soil Color Charts, on the basis of hue, value and chroma. In contrast to deeper soil horizons, topsoil contains a high proportion of nutrients (especially nitrogen) and organic matter (humus) and also a large quantity of soil organisms in addition to the main mineral constituents (fine sand, silt and clay). Aerobic bacteria usually live in topsoil, whereas subsoil is not humus-rich or only slightly humus-rich, exhibits only little root penetration and contains hardly any life. Generally, only topsoil is worked by agriculture. Topsoil and subsoil are also called mineral soils because of their high proportion of inorganic matter of at least 70 percent by weight. They have a proportion of organic matter of not more than 30% by weight. An organic soil horizon comprising a proportion of more than 30 percent by weight (approx. 90 percent by volume) of organic matter may be present above the topsoil, especially under forest use. The entirety of the organic matter in the soil minus the roots and the soil organisms is called humus. This includes all dead plant and animal matter and organic conversion products thereof that are present in and on the soil. Humus is not a uniform soil fraction, but is the sum of varying degrees of decomposition of transformed organic matter. The amount of organic matter in a soil is usually determined by ascertaining the organic carbon content (Corg content) in the soil. Assuming an average Corg content of organic matter in the soil of 58%, this can be used to calculate the humus content, i.e., the content of organic matter, by multiplication of the Corg content by the empirical factor 1.72. Corg content can be determined by various methods, for example by elemental analysis (dry ashing, DIN ISO 10964), wet ashing of organic matter (Lichterfelder method, DIN ISO 19684 part 2) or determination of the loss on ignition (DIN ISO 19684 part 3). Corg content is usually measured in a soil dried at above 100° C.

Compared to subsoils, topsoils generally have higher biological activity, which leads to dynamic release of nutrient elements from the organic matter and to the formation of aggregate structures.

Subsoils on the other hand are characterized by low contents of humus and a blocky/prismatic/columnar/platy structure or massive structure and can also be easily visually distinguished from topsoils on the basis of these features. Nutrients are mainly released in topsoil from the minerals as a result of weathering.

Furthermore, A and B horizons can be additionally divided into further subclasses. According to the invention, A horizon and B horizon always also include the respective subclasses of said horizons.

Depending on the parent rock, the C horizons of soils can be solid to loose, calcareous to lime-free and sandy to clayey (texture). Rock strength, lime content and texture are important factors for the rate of soil formation and thus deciding factors for the thickness of the soils, the pedogenetic horizons and the associated soil properties, such as soil structure.

A person skilled in the art can easily distinguish on the basis of one or more features the A horizon, B horizon and C horizon of a specific soil or soil sample on the basis of core drillings in various soils. Said features are, for example, color, color distribution, color intensity, proportion of inorganic matter, proportion of organic matter, degree of root penetration, composition of the main mineral constituents, aggregation of primary particles, proportion of nutrients (e.g., nitrogen or phosphorus), or proportion and type of soil organisms.

Terrestrial and semiterrestrial soils are exposed to external influences that can influence the natural composition and the functions of the soils. These include, for example, pollutants which are introduced or have been introduced into the soils by human activity. Salts of, for example, heavy metals, such as Pb, Hg, Cd, Cr, Ni, Cu cations, which are known to have high toxicity, can be referred to as pollutants.

Not only can the uptake of these metal ions into plants considerably interfere with their growth, but the metal ions can also enter the animal and human food chain, where they accumulate. If these toxic metal ions are not taken up by plants, they can be leached into the groundwater across the soil and thus enter the water cycle. But also ubiquitous anions essential to plant growth, such as nitrates or phosphates, can be introduced into the soil in harmfully high concentrations. Manure spreading at high levels, wastewater irrigation or spreading of other waste materials such as sewage sludge or harbor mud lead to an accumulation of the aforementioned heavy metals or anions in the soil. What cannot be taken up by plants and cannot be bound by the soils is leached with the leachate and can lead to the legally permitted maximum limits, for example for phosphate in groundwater, being exceeded.

As a result, the groundwater must undergo elaborate purification until it receives the required purity. For example, the water must be pumped from underground in order to purify it aboveground before use thereof or to recycle it into the water cycle.

Available for this purpose are the known water treatment methods according to the prior art, such as flocculation filtration, ion-exchange methods, adsorption, membrane methods or reverse osmosis, to name but a few (Water Treatment, American Water Works Association, 3rd Edition, 2003, pages 1 to 7).

The aforementioned methods are highly effective, but are extremely cost-intensive, energy-intensive and labor-intensive. Besides the sometimes very high investment costs and running costs, there is also the need for close and constant monitoring of water quality, by means of which observance of discharge limits is monitored. Moreover, the methods are always downstream methods that purify already contaminated water.

Another method for reducing the contents, availability and mobility of pollutants in soils is soil remediation. Various methods for soil remediation are known from the prior art. Known for example are numerous phytoremediation methods, the aim of which is to achieve specific and maximum uptake of pollutants by plants, even before the ions can be leached into the groundwater, through sowing of special fast-growing plants. Thereafter, the plants are harvested and incinerated, the pollutants thus remaining fixed in the ash.

However, this method has, first of all, the disadvantage that it is highly labor-intensive and, moreover, takes a very long time before the pollutants have been completely removed from the soil. Multiple steps of sowing, harvesting and disposal are often necessary. Moreover, with this method, it is not possible to use the soil, for example for agricultural purposes, while the remediation plants are growing.

Another option is radical soil remediation. According to one alternative, the entire depth of the contaminated soil is completely removed and, in the simplest case, permanently disposed of in a hazardous waste dump. According to another alternative, the pollutants are removed from the soil by a soil washing plant and the soil is returned to the surface. However, this method is only usable in special cases for economic and agricultural reasons.

Even with soil washing (ex situ method), although the pollutants can be technically removed, valuable and essential soil constituents are also irreversibly removed from the soil together with said pollutants.

To reduce leaching and at the same time reduce uptake by plants, the mobility of the aforementioned pollutants can be reduced by near-surface mixing of various adsorptive substances into the soil, which has been experimentally tested and described.

WO2005/014492 describes a method for soil or groundwater remediation with spherical and porous zero-valent iron particles. However, specific details in relation to the nature of the soils, to the nature of the mixing with the soils and to the adsorbent properties of said zero-valent iron particles are not given here.

EP1318103A2 describes iron particles comprising a metallic α-Fe phase and a content of magnetic Fe₃O₄ for purification of contaminated soils or of groundwater. Said iron particles are prepared from goethite (α-FeOOH) by partial reduction. However, specific details in relation to the nature of the soils and to the nature of the mixing with the soils are not described here. The preparation of said iron particles is highly elaborate and therefore not economically feasible for use of large quantities.

In U.S. Pat. No. 6,527,691 B1, magnetites produced in situ in soils by chemical reaction of soluble iron salts with sodium hydroxide solution are produced as reactive barriers, for example around tanks which have been filled with pollutants and have leaks. Substances present therein are thus bound. Owing to the handling of aggressive chemicals, this method is only possible with effort and with high safety precautions and is therefore prohibited in soils, for example arable land, on which plants grow.

CN107501012A1 describes a mixture of 20 to 30 parts of attapulgite powder, 10 to 20 parts of sodium pyrophosphate, 30 to 45 parts of activated weathered carbon, 10 to 25 parts of fungal residues, 1 to 5 parts of iron powder, 10 to 20 parts of struvite and 1 to 3 parts of sucrose that is placed below the soil in greenhouses as an adsorbent barrier. Nitrates and phosphates are retained in this barrier, thereby preventing leaching thereof from the soil by watering. Disadvantages: elaborate preparation of the mixture, not economically feasible when using large quantities.

However, the near-surface incorporation of metal oxides means that the substances required for plant growth (P, Zn, Cu, etc.) are also reduced in concentration in the soil solution of the topsoil and that the plants may thus be insufficiently supplied with said substances owing to adsorptive binding. In addition, reduced leaching of said substances is only achieved if accumulation thereof is restricted to the near-surface region where mixing was carried out. If the substances have already penetrated into the subsoil, it is no longer possible to effectively reduce leaching thereof through the near-surface incorporation of oxides. Moreover, the reduction of the availability of phosphorus and trace nutrient elements in the topsoil prevents these contaminated soils from being remediated through the removal of phosphorus and heavy metals by plants (phytoremediation).

It is therefore an object of the present invention to avoid the entry of harmful soil constituents into the groundwater, for example by leaching, thus making it possible to dispense with subsequent groundwater treatment. It is also an object of the present invention to not completely remove specific ions, for example phosphate, from the topsoil or fix them in the soil, otherwise ions essential for plants are immobilized and can no longer be taken up by plants.

### DESCRIPTION OF THE INVENTION

Surprisingly, this object was achieved by an adsorber material and a mineral soil containing an adsorber material.

The adsorber material according to the invention comprises as components at least from 0% to 10% by weight of topsoil, from 1% to 99% by weight of subsoil, from 1% to 99% by weight of adsorbent and optionally further constituents, wherein the percentages by weight are measured in dry matter and the contents of the individual components add up to 100% by weight.

Preferably, the adsorber material according to the invention comprises as components at least from 0% to 10% by weight of topsoil, from 80% to 99% by weight of subsoil, from 1% to 20% by weight of adsorbent and optionally further constituents, wherein the percentages by weight are measured in dry matter and the contents of the individual components add up to 100% by weight.

Particularly preferably, the adsorber material according to the invention comprises as components at least from 0% to 10% by weight of topsoil, from 90% to 99% by weight of subsoil, from 1% to 10% by weight of adsorbent and optionally further constituents, wherein the percentages by weight are measured in dry matter and the contents of the individual components add up to 100% by weight.

According to the invention, topsoil is defined as the A horizon as specified according to the terminology in use in Germany. Said A horizon and its boundary to the B horizon can be clearly identified by a person skilled in the art in a core drilling of the mineral soil under investigation. The A horizon preferably has a high mineral fraction of 70 to 100 percent by weight.

According to the invention, subsoil is defined as the B horizon as specified according to the terminology in use in Germany. Said B horizon and its boundary to the A horizon and to the C horizon can be clearly identified by a person skilled in the art in a core drilling of the mineral soil under investigation. The B horizon preferably has a mineral fraction of 70 to 100 percent by weight.

Topsoil and subsoil are clearly defined terms in soil science, and they are also defined inter alia in statutory regulations, for example in the Verordnung zur Einführung einer Ersatzbaustoffverordnung, zur Neufassung der Bundes-Bodenschutz-und Altlastenverordnung und zur Änderung der Deponieverordnung und der Gewerbeabfallverordnung [Ordinance introducing substitute construction materials ordinance, revising the federal soil protection and contaminated sites ordinance and amending the landfill ordinance and the commercial waste ordinance] of Jul. 9, 2021, German Federal Law Gazette 2021, Part I No. 43, issued in Bonn on Jul. 16, 2021, page 2717: Article 2 Federal soil protection and contaminated sites ordinance (BBodSchV), Section 1, § 2 Definitions, Number 2: Topsoil, Number 3: Subsoil.

The delimitation between topsoil and subsoil in various soils is also detailed in standard works on soil science, for example in Bodenkundliche Kartieranleitung [Pedological mapping guide], KA5, 2005, ed.: Wolf Eckelmann; E. Schweizerbart'sche Verlagsbuchhandlung, chapter 5.6 on horizon-based data, subchapter 5.6.3.3.3 on mineral horizons, pages 92 to 98. These describe in detail the properties of the different soil horizons including their subclasses, the additional symbols of which come after the main symbol A (for topsoil), for example Ah, or after the main symbol B (for subsoil), for example Bv.

Preferably, all A horizons including the A transition horizons are covered by the definition of topsoil according to the invention, and all B horizons are covered by the definition of subsoil according to the invention.

Adsorbents that can be used are, for example, activated carbon, ion exchangers, clay minerals and zeolites, which have a high binding capacity with respect to substances. Some iron oxides, but particularly iron oxyhydroxides, have a very high adsorption capacity with respect to arsenate, vanadate, antimonate, chromate or phosphate ions. Moreover, numerous heavy metal cations such as cadmium, lead, mercury, nickel or copper ions are effectively adsorbed on the iron oxyhydroxide surface.

The at least one adsorbent present in the adsorber material according to the invention is selected from the group consisting of activated carbon, ion exchangers, clay minerals, zeolites, iron oxides and iron oxyhydroxides, or any mixtures thereof. Preferred adsorbents are iron oxides and iron oxyhydroxides. Particularly preferred adsorbents are iron oxyhydroxides.

It has been found that, surprisingly, iron oxides and iron oxyhydroxides, in particular iron oxyhydroxides, have a high binding power with respect to the aforementioned ions, even if they are introduced in granular form into the horizon below the topsoil, without substantially changing soil permeability at the same time. The pollutant ions are present in the topsoil and, as a result of binding to the iron oxide surface in the adsorber material according to the invention, do not reach the subsoil and thus cannot be leached into the groundwater either.

As described for example in EP1582505B1 and U.S. Pat. No. 7,651,973B2, specific iron oxyhydroxides have high mechanical stability in granular form with respect to abrasion and water flow. Maintaining the granular structure of the adsorbent in the soil is of vital importance. Firstly, the soil structure remains unchanged after the granules have been introduced, and compaction and/or sticking of the soil structure does not occur, which would be the case with pulverulent adsorbers. Moreover, the granules are disintegration-stable, and so they do not disintegrate into powder in the soil, which would lead to unwanted leaching of the pollutant-contaminated iron oxyhydroxide powder into the groundwater. Granules can also be metered easily and in a largely dust-free manner, which is important for the production of the adsorber material.

Therefore, adsorbents that are very particularly preferred are iron oxyhydroxides, i.e., goethite having the modification α-FeOOH, in piece form, also called granular form. They usually have a grain size of 0.2 to 40 mm, preferably of 0.2 to 20 mm. The production of these iron oxyhydroxide pieces is described, for example, in EP1582505B1 and EP1328476B1. Therefore, adsorbents that are likewise very particularly preferred are iron oxyhydroxide pieces having the modification α-FeOOH and specific BET surface areas of greater than 20 m²/g, in particular of 80 to 400 m²/g. Examples of such iron oxide hydroxide pieces or iron oxyhydroxide granules are the products Bayoxide® E 33 and Bayoxide® E 33 HC, which are produced by LANXESS Deutschland GmbH. The iron oxyhydroxides preferably have a high specific BET surface area, thus ensuring rapid adsorption kinetics of the pollutants on the granules. Adsorbents that are likewise very particularly preferred are yellow pigments, generally acicular goethite having the modification α-FeOOH, in granular form or in the form of compacts, as produced for example by LANXESS, for example from the Bayferrox or Bayoxide product line.

The adsorber material according to the invention is preferably present in the soil as a layer, particularly preferably as a horizontal layer, having a layer thickness of 1 to 200 mm, preferably of 2 to 100 mm. Established measurement methods are available to a person skilled in the art for the determination of the content of adsorbents in dry solids mixtures.

The invention also comprises the production of the adsorber material according to the invention by a method, characterized in that the adsorbent is homogeneously mixed with subsoil and optionally with topsoil in a content of 1% to 99% by weight, preferably of 1% to 10% by weight, particularly preferably of 1% to 5% by weight, based on the sum of the total dry matter of the adsorbent used, the topsoil used and the subsoil used.

In a preferred embodiment, the adsorber material according to the invention is produced by introducing the adsorbent(s), for example activated carbon, ion exchangers, clay minerals, zeolites, iron oxides and iron oxyhydroxides or any mixtures thereof, preferably iron oxyhydroxides, particularly preferably iron oxyhydroxide pieces, below the topsoil having strong root penetration. This can be achieved on the one hand by either mixing the adsorbent as such into the subsoil having little root penetration or applying said absorbent as a layer, preferably as a horizontal layer, to the surface of said subsoil. This can be achieved in a preferred embodiment, for example with suitable technical devices, by removing the topsoil at the boundary to the subsoil, for example on an arable land, by then applying the adsorbent to the subsoil as a layer, preferably as a horizontal layer, and by, as a last step, reapplying the topsoil, for example turned by 180 degrees, to said layer. This can be achieved in a further preferred embodiment, for example with suitable technical devices, by removing the topsoil at the boundary to the subsoil, for example on an arable land, by then removing a defined layer of subsoil, by then mixing the adsorbent with the removed subsoil and by then applying this mixture to the remaining subsoil as a layer, preferably as a horizontal layer, and by, as a last step, reapplying the topsoil, for example turned by 180 degrees, to the adsorber material present as a layer.

Technical means that can be used to introduce the iron oxyhydroxide granules into the soil are, for example, plowshares which lift the topsoil from the subsoil, loosen it and optionally turn it, such that the adsorber material and/or the adsorbent can be introduced before the topsoil is reapplied over the adsorber material and/or the adsorbent.

According to the invention, this results in a permeable, reactive layer at the topsoil-subsoil boundary layer or in the subsoil itself that effectively reduces leaching of anions, for example phosphate and heavy metals, without impeding the uptake of these substances into plants. An example that may be mentioned here is the cultivation of plants, for example for removal of heavy metals in the context of phytoremediation.

The method according to the invention also results in a new mineral soil having a new structure. It can therefore be said that soil is newly formed anthropogenically. The invention thus also comprises a new mineral soil. This soil according to the invention is characterized in that it has a top layer of topsoil, and a layer of adsorber material according to the invention underneath and a layer of subsoil underneath.

Preferably, the soil according to the invention has a layer of adsorber material and/or adsorbent having a layer thickness of 1 mm to 200 mm, preferably of 2 mm to 100 mm.

Likewise preferably, the topsoil present in the mineral soil according to the invention has a mineral fraction of 70 to 100 percent by weight.

Likewise preferably, the subsoil present in the mineral soil according to the invention has a mineral fraction of 70 to 100 percent by weight.

Likewise preferably, the topsoil and subsoil of a specific soil can be clearly distinguished from each other by further features such as color, color distribution, color intensity, proportion of inorganic matter, proportion of organic matter, degree of root penetration, composition of the main mineral constituents, aggregation of primary particles, proportion of nutrients (e.g., nitrogen or phosphorus), or proportion and type of soil organisms.

Likewise, the layer of adsorber material present in the mineral soil according to the invention contains an adsorbent selected from the group consisting of activated carbon, ion exchangers, clay minerals, zeolites, iron oxides and iron oxyhydroxides, or mixtures thereof.

Adsorbents in the mineral soil according to the invention that are very particularly preferred are iron oxyhydroxides, i.e., goethite having the modification α-FeOOH, in piece form, also called granular form. They usually have a grain size of 0.2 to 40 mm, preferably of 0.2 to 20 mm. Adsorbents in the mineral soil according to the invention that are likewise very particularly preferred are iron oxyhydroxide pieces having the modification α-FeOOH and specific BET surface areas of greater than 20 m²/g, in particular of 80 to 400 m²/g. Examples of such iron oxide hydroxide pieces or iron oxyhydroxide granules are the products Bayoxide® E 33 and Bayoxide® E 33 HC, which are produced by LANXESS Deutschland GmbH. The iron oxyhydroxides likewise very particularly preferably have a high specific BET surface area, thus ensuring rapid adsorption kinetics of the pollutants on the granules. Adsorbents that are likewise very particularly preferred are yellow pigments, generally acicular goethite having the modification α-FeOOH, in granular form or in the form of compacts, as produced for example by LANXESS, for example from the Bayferrox or Bayoxide product line.

In the mineral soil according to the invention, a person skilled in the art can easily distinguish, on the basis of one or more features, between the topsoil, the layer of adsorber material and/or adsorbent and the subsoil on the basis of a soil sample, for example in the form of core drillings. Said features are, for example, color, color distribution, color intensity, proportion of inorganic matter, proportion of organic matter, proportion of adsorbents, degree of root penetration, composition of the main mineral constituents, aggregation of primary particles, proportion of nutrients (e.g., nitrogen or phosphorus), or proportion and type of soil organisms.

The invention also relates to a method for producing the soils according to the invention, characterized in that the adsorber material and/or adsorbent according to the invention is introduced between topsoil and subsoil.

To introduce the adsorber material and/or the adsorbent into the boundary layer between topsoil and subsoil, what can be preferably used are technical devices which lift the topsoil from the subsoil, loosen it and optionally turn it, such that the adsorber material and/or the adsorbent can be introduced before the topsoil is reapplied over the layer of adsorber material and/or adsorbent according to the invention that is produced. Particularly preferably, the technical device used is a plow comprising plowshares which lift the topsoil from the subsoil, loosen it and optionally turn it, such that the adsorber material and/or the adsorbent can be introduced before the topsoil is reapplied over the layer of adsorber material and/or adsorbent according to the invention that is produced. This can be achieved in a preferred embodiment, for example with suitable technical devices, by removing the topsoil at the boundary to the subsoil, for example on an arable land, by then applying the adsorber material to the subsoil as a layer, and by, as a last step, reapplying the topsoil, for example turned by 180 degrees, to the layer of adsorber material and/or adsorbent that is produced.

The adsorber material according to the invention and the soils according to the invention can be easily identified through core drillings in the soil in question, by taking samples of different layer thicknesses at the drill cores around the boundary layer between subsoil and the topsoil.

In these samples, the content of adsorbent in relation to topsoil and subsoil is then determined in the relevant layer thickness of the sample through suitable methods of quantitative measurement.

The invention further relates to the use of adsorbents selected from the group consisting of activated carbon, ion exchangers, clay minerals, zeolites, iron oxides and iron oxyhydroxides, including preferred and particularly preferred embodiments thereof as described above, for production of the adsorber material according to the invention.

The invention further relates to the use of the above-described adsorber material, including preferred and particularly preferred embodiments thereof as described above, for production of the above-described mineral soils according to the invention, including preferred and particularly preferred embodiments thereof as described above.

The adsorber materials according to the invention and the mineral soils according to the invention that are newly formed therefrom have the advantage that, surprisingly, the availability of target substances for plants in topsoil remains unchanged, but the contamination of subsoil and thus of groundwater is minimized.

### EXAMPLES

### I. Production of the Adsorber Material (Mixture of Subsoil and Adsorbent)

95 parts by weight of subsoil having a known content of Fe³⁺ were mixed with 5 parts by weight of α-FeOOH pieces (Bayoxide® E33 from LANXESS Deutschland GmbH) having a grain size of 0.5 to 2 mm and BET of 130 m²/g in such a way that a mixture determined as homogeneous by visual inspection was produced.

II. Incorporation of the Adsorber Material into the Top Layer of the Subsoil for Production of the Mineral Soil

This was achieved by transferring a mixture from Example 1 into a percolation column A as the bottom layer. For comparison, the same mass of the same subsoil without adsorbent was filled into a percolation column B. The same mass of the same topsoil was filled into both percolation columns as the top layer.

### III. Measurement of the Relative Retention of Pollutants in the Adsorber Material

To test the effectiveness of the adsorber material according to the invention that was produced according to Example 1 by mixing of subsoil with granular iron oxides, percolation tests were carried out with soil columns.

This was achieved by spraying the percolation columns A and B from Example Il with water and collecting the eluates from percolation column A (eluate A) and percolation column B (eluate B) in various fractions of equal size. In the eluates A and B, the concentration in the eluates “c (eluate A)” and “c (eluate B)” of ortho-phosphate, phosphorus (total phosphorus), lead, copper ions, cadmium ions and zinc ions was measured. The respective relative retention of the respective pollutants in the adsorber material (relative retention r, in percent) was calculated by means of the following formula

$$r = [ c ( eluate B ) - c ( eluate A ) ] \cdot 100 / c ( eluate B )$$

The contents of Cu, Zn, Pb and Cd in the eluates and in the loaded iron oxyhydroxide or solutions were determined by customary methods, for example by means of atomic adsorption spectrometry or by means of mass spectrometry (ICP-MS) according to DIN 38406-29 (1999) or by means of optical emission spectroscopy (ICP-OES) according to EN-ISO 11885 (1998) with inductively coupled plasma as the excitation unit in each case.

These tests demonstrated that mixing of 5% by weight of iron oxyhydroxide granules (Bayoxide® E33, LANXESS Deutschland GmbH) into the subsoil material of a sewage farm soil (site G) and of an agricultural soil (site H) leads to a significant reduction in the introduction of these pollutants into the underlying subsoil (Table 1).

TABLE 1
Average relative retention for two soils:

| | Relative retention r [%] | |
|---|---|---|
| Pollutant | Soil from site G | Soil from site H |
| Ortho-phosphate | 98 | 96 |
| Total phosphorus | 96 | 94 |
| Lead | 81 | |
| Cadmium | 54 | |
| Copper | 93 | 87 |
| Zinc | 71 | |

The specific BET surface area of the iron oxyhydroxides present as adsorbers in the mixtures according to the invention was determined by means of the carrier gas method (He:N₂=90:10) by the single-point method according to DIN 66131 (1993). Before measurement, the sample was heated at 140° C. for 1 h in a stream of dry nitrogen.

1. An adsorber material comprising as components at least from 0% to 10% by weight of topsoil, from 1% to 99% by weight of subsoil, from 1% to 99% by weight of adsorbent and optionally further constituents, wherein the percentages by weight are measured in dry matter and the contents of the individual components add up to 100% by weight.

2. The adsorber material as claimed in claim 1, containing at least from 0% to 10% by weight of topsoil, from 80% to 99% by weight of subsoil, from 1% to 20% by weight of adsorbent and optionally further constituents, wherein the percentages by weight are measured in dry matter and the contents of the individual components add up to 100% by weight.

3. The adsorber material as claimed in claim 1, containing at least from 0% to 10% by weight of topsoil, from 90% to 99% by weight of subsoil, from 1% to 10% by weight of adsorbent and optionally further constituents, wherein the percentages by weight are measured in dry matter and the contents of the individual components add up to 100% by weight.

4. The adsorber material as claimed in claim 1, characterized in that the adsorbent is selected from the group consisting of activated carbon, ion exchangers, clay minerals, zeolites, iron oxides and iron oxyhydroxides, or mixtures thereof.

5. The adsorber material as claimed in claim 1, characterized in that the adsorbent is an iron oxyhydroxide in piece form having a grain size of 0.2 to 40 mm.

6. The adsorber material as claimed in claim 5, characterized in that, as adsorbent, the iron oxyhydroxide piece has the modification α-FeOOH and has specific BET surface areas of greater than 20 m²/g.

7. The adsorber material as claimed in claim 1, characterized in that the adsorber material is present as a layer having a layer thickness of 1 to 200 mm.

8. The adsorber material as claimed in claim 1, characterized in that topsoil and subsoil are distinguished in one or more features selected from color, color distribution, color intensity, proportion of inorganic matter, proportion of organic matter, degree of root penetration, composition of the main mineral constituents, aggregation of primary particles, proportion of nutrients (e.g., nitrogen or phosphorus), or proportion and type of soil organisms.

9. A method for producing the adsorber material as claimed in claim 1, characterized in that the adsorbent is homogeneously mixed with subsoil and optionally with topsoil in a content of 1% to 99% by weight, based on the sum of the total dry matter of the topsoil used and the subsoil used.

10. A mineral soil comprising a top layer of topsoil, a layer of adsorber material and/or adsorbent as claimed in claim 1 underneath, and a layer of subsoil underneath.

11. The mineral soil as claimed in claim 10, wherein the layer of adsorber material and/or adsorbent has a layer thickness of 1 mm to 200 mm.

12. A method for producing a mineral soil as claimed in claim 10, wherein the adsorber material produced as claimed in claim 9 or the adsorbent as claimed in claim 4 is introduced between topsoil and subsoil.

13. A method for producing a mineral soil as claimed in claim 10, wherein the adsorber material produced as claimed in claim 9 or the adsorbent as claimed in claim 4 is introduced between topsoil and subsoil by means of a plow comprising plowshares which lift the topsoil from the subsoil, loosen it and optionally turn it, such that the adsorber material and/or the adsorbent can be introduced before the topsoil is reapplied over the layer of adsorber material and/or adsorbent that is produced.

14. Use of adsorbents selected from the group consisting of activated carbon, ion exchangers, clay minerals, zeolites, iron oxides and iron oxyhydroxides for production of the adsorber material as claimed in claim 1 comprising introducing the absorbents between topsoil and subsoil.

15. The use of adsorbents as claimed in claim 14, wherein the iron oxyhydroxide is in piece form having a grain size of 0.2 to 40 mm.

16. The use of adsorbents as claimed in claim 14, wherein the iron oxyhydroxide has the modification α-FeOOH and has specific BET surface areas of greater than 20 m²/g.

17. The use of adsorber materials as claimed in claim 1 and/or of adsorbents as claimed in claim 4 for production of mineral soil as claimed in claim 10.
